(19) United States
(12) Patent Application Publication
(10) Pub. No.: US 2026/0020621 A1
(43) Pub. Date: Jan. 22, 2026

(54) AEROSOL PROVISION DEVICE

(71) Applicant: NICOVENTURES TRADING LIMITED, London (GB)

(72) Inventors: Michael THOMAS, London (GB); Zheng XIAOYUAN, Longgang District (CN)

(21) Appl. No.: 18/996,280

(22) PCT Filed: Jul. 20, 2023
(86) PCT No.: PCT/EP2023/070220

§ 371 Date: Jan. 17, 2025

(30) Foreign Application Priority Data
Jul. 21, 2022 (CN) 202210860886.1
Aug. 3, 2022 (GB) 2211348.4

(51) Int. Cl. A24F 40/85; A24F 40/20; A24F 40/46; A24F 40/70; H05B 3/22

(52) U.S. Cl. CPC A24F 40/85; A24F 40/20; A24F 40/46; A24F 40/70; H05B 3/22

(57) ABSTRACT

An aerosol provision device including a main housing having a tubular element surrounding a heating element. The tubular element includes a first aperture through which a tool can be inserted, in use, in order to clean the heating element and/or to assist in the removal of an aerosol generating article attached to the heating element.

### RELATED APPLICATIONS

The present application is a National Phase entry of PCT Application No. PCT/EP2023/070220 filed Jul. 20, 2023, which claims priority to CN Application No. 202210860886.1 filed Jul. 21, 2022 and GB Application No. 2211348.4 filed Aug. 3, 2022, each of which is hereby incorporated by reference in their entirety.

### TECHNICAL FIELD

The present invention relates to an aerosol provision device, an aerosol generating system and a method of manufacturing an aerosol provision device.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation.

It is known to use a resistive heater to create aerosol from a suitable medium.

Conventional aerosol provision devices comprise a cylindrical heating chamber into which a rod shaped consumable is inserted.

It is known to provide an aerosol provision device which is charged by a charging unit and wherein electrical power is supplied by the charging unit to the aerosol provision device in order to charge the aerosol provision device.

It is desired to provide an improved aerosol provision device.

### SUMMARY

According to an aspect there is provided an aerosol provision device comprising:
a main housing comprising a tubular element surrounding a heating element;
wherein the tubular element comprises a first aperture through which a tool can be inserted, in use, in order to clean the heating element and/or to assist in the removal of an aerosol generating article attached to the heating element.

Known aerosol provision devices comprising a heating element suffer from the problem that the heating element may become dirty in use and also that an aerosol generating article may become stuck to the heater. The aerosol provision device according to various embodiments is particularly beneficial in that a tool, such as a cleaning tool, can be inserted through the first aperture in order to clean the heating element. Furthermore, a tool can also be inserted through the first aperture in order to assist in the removal of an aerosol generating article (or a portion of an aerosol generating article) which may have become stuck to the heating element. The first aperture may also be used as an inspection port for use in checking the alignment and condition of the heating element, and may also be used to calibrate the heating profile of the heating element.

Optionally, the aerosol provision device further comprises a removable cap which is attached, in use, to the main housing;

Optionally, the heating element has a first profile, a first length L1, a first width W1 and a first surface area A1 and the first aperture has a second profile, a second length L2, a second width W2 and a second area A2.

Optionally, the first profile substantially corresponds with the second profile.

Optionally, L1/L2 is in the range 0.5-0.6, 0.6-0.7, 0.7-0.8, 0.8-0.9, 0.9-1.0, 1.0-1.1, 1.1-1.2, 1.2-1.3, 1.3-1.4 or 1.4-1.5.

Optionally, W1/W2 is in the range 0.5-0.6, 0.6-0.7, 0.7-0.8, 0.8-0.9, 0.9-1.0, 1.0-1.1, 1.1-1.2, 1.2-1.3, 1.3-1.4 or 1.4-1.5.

Optionally, A1/A2 is in the range 0.5-0.6, 0.6-0.7, 0.7-0.8, 0.8-0.9, 0.9-1.0, 1.0-1.1, 1.1-1.2, 1.2-1.3, 1.3-1.4 or 1.4-1.5.

Optionally, L2 is in the range 1-30 mm, 3-20 mm, or 5-10 mm.

Optionally, W2 is in the range 1-15 mm, 2-8 mm, or 3-5 mm.

Optionally, the first profile comprises a polygonal profile.

Optionally, the first profile comprises a triangular, square, rectangular, pentagonal, hexagonal, septagonal or octagonal profile. Other embodiments are contemplated wherein the first profile may comprise a non-polygonal profile or wherein the first profile may comprise a higher order polygonal profile.

Optionally, the second profile comprises a polygonal profile.

Optionally, the second profile comprises a triangular, square, rectangular, pentagonal, hexagonal, septagonal or octagonal profile. Other embodiments are contemplated wherein the second profile may comprise a non-polygonal profile or wherein the second profile may comprise a higher order polygonal profile.

Optionally, the tubular element has a longitudinal axis and the first aperture is elongated in a direction parallel to the longitudinal axis.

Optionally, the heating element comprises a resistive heating element.

Optionally, the resistive heating element comprises a substrate and one or more electrically conductive tracks provided on the substrate.

Optionally, the heating element comprises a first face, an edge portion and a second face and wherein the first aperture is aligned with the first face.

Optionally, the tubular element further comprises a second aperture through which a tool can be inserted, in use, in order to clean the heating element and/or to assist in the removal of an aerosol generating article attached to the heating element.

Optionally, the second aperture is aligned with the second face.

Optionally, the second aperture is located opposite the first aperture.

Optionally, the tubular element has a truncated circular cross-sectional profile comprising a first arcuate section having a curved outer surface and a second linear section having a planar outer surface.

Optionally, the first aperture is located in the second linear section.

Optionally, the second aperture is inclined at an angle <30°, 30-60°, 60-90°, 90-120°, 120-150° or 150-180° relative to the first aperture.

According to another aspect there is provided an aerosol generating system comprising:
an aerosol provision device as described above; and
an aerosol generating article.

According to another aspect there is provided a method of manufacturing an aerosol provision device comprising:
locating a tubular element around a heating element, the tubular element having a first inspection port; and
using an inspection device to inspect the heating element through the first inspection port.

The method of manufacturing an aerosol provision device according to various embodiments is particularly beneficial in that during the manufacturing process a check, for example, can be made that the heating element has been located in the correct orientation and/or the integrity of conductive tracks provided on the heating element can be verified by inspecting the heating element via one or more inspection ports provided in a tubular element which surrounds the heating element.

Optionally, the inspection device comprises an imaging device, and wherein inspection of the heating element comprises taking one or more images of the heating element through the first inspection port.

Optionally, the heating element has a first profile, a first length L1, a first width W1 and a first surface area A1 and the first inspection port has a second profile, a second length L2, a second width W2 and a second area A2.

Optionally, the first profile substantially corresponds with the second profile.

Optionally, L1/L2 is in the range 0.5-0.6, 0.6-0.7, 0.7-0.8, 0.8-0.9, 0.9-1.0, 1.0-1.1, 1.1-1.2, 1.2-1.3, 1.3-1.4 or 1.4-1.5.

Optionally, W1/W2 is in the range 0.5-0.6, 0.6-0.7, 0.7-0.8, 0.8-0.9, 0.9-1.0, 1.0-1.1, 1.1-1.2, 1.2-1.3, 1.3-1.4 or 1.4-1.5.

Optionally, A1/A2 is in the range 0.5-0.6, 0.6-0.7, 0.7-0.8, 0.8-0.9, 0.9-1.0, 1.0-1.1, 1.1-1.2, 1.2-1.3, 1.3-1.4 or 1.4-1.5.

Optionally, L2 is in the range 1-30 mm, 3-20 mm, or 5-10 mm.

Optionally, W2 is in the range 1-15 mm, 2-8 mm, or 3-5 mm.

Optionally, the first profile comprises a polygonal profile.

Optionally, the first profile comprises a triangular, square, rectangular, pentagonal, hexagonal, septagonal or octagonal profile. Other embodiments are contemplated wherein the first profile may comprise a non-polygonal profile or wherein the first profile may comprise a higher order polygonal profile.

Optionally, the second profile comprises a polygonal profile.

Optionally, the second profile comprises a triangular, square, rectangular, pentagonal, hexagonal, septagonal or octagonal profile. Other embodiments are contemplated wherein the second profile may comprise a non-polygonal profile or wherein the second profile may comprise a higher order polygonal profile.

Optionally, the tubular element has a longitudinal axis and the first aperture is elongated in a direction parallel to the longitudinal axis.

Optionally, the heating element comprises a resistive heating element.

Optionally, the resistive heating element comprises a substrate and one or more electrically conductive tracks provided on the substrate.

Optionally, wherein the heating element comprises a first face, an edge portion and a second face and wherein the first aperture is aligned with the first face.

Optionally, the tubular element further comprises a second inspection port.

Optionally, the method further comprises using the inspection device or a further inspection device to inspect the heating element through the second inspection port.

Optionally, the inspection device or further inspection device comprises an imaging device, and wherein inspecting the heating element comprises taking one or more images of the heating element through the second inspection port.

Optionally, the second inspection port is aligned with the second face.

Optionally, the second inspection port is located opposite the first inspection port.

Optionally, the tubular element has a truncated circular cross-sectional profile comprising a first arcuate section having a curved outer surface and a second linear section having a planar outer surface.

Optionally, the first inspection port is located in the second linear section.

Optionally, the second inspection port is inclined at an angle <30°, 30-60°, 60-90°, 90-120°, 120-150° or 150-180° relative to the first inspection port.

Optionally, the method further comprises analysing an output of the inspection device in order to assess one or more properties of the heating element and/or the orientation of the heating element.

Optionally, the method further comprises analysing the one or more images in order to assess one or more properties of the heating element and/or the orientation of the heating element.

Optionally, the first inspection port and/or the second inspection port include an optically transparent member.

Optionally, the first inspection port comprises an aperture in the tubular element.

Optionally, the second inspection port comprises an aperture in the tubular element.

### BRIEF DESCRIPTION OF THE DRAWINGS

Various embodiments will now be described, by way of example only, and with reference to the accompanying drawings in which:

FIG. 1 shows an aerosol provision device located within a charging unit according to an embodiment;

FIG. 2 shows a cross-sectional view of an aerosol provision device located within a charging unit;

FIG. 3 shows a perspective view, from above, of the aerosol provision device with the removable cap removed therefrom; and

FIG. 4 show shows a side-on view of the aerosol provision device.

### DETAILED DESCRIPTION

Aspects and features of certain examples and embodiments are discussed or described herein. Some aspects and features of certain examples and embodiments may be implemented conventionally and these are not discussed or described in detail in the interests of brevity. It will thus be appreciated that aspects and features of apparatus and methods discussed herein which are not described in detail may be implemented in accordance with conventional techniques for implementing such aspects and features.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

Aerosol-generating material is a material that is capable of generating aerosol, for example when heated, irradiated or energized in any other way. Aerosol-generating material may, for example, be in the form of a solid, liquid or semi-solid (such as a gel) which may or may not contain an active substance and/or flavorants.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise one or more active substances and/or flavors, one or more aerosol-former materials, and optionally one or more other functional material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

A consumable is an article comprising or consisting of aerosol-generating material, part or all of which is intended to be consumed during use by a user. A consumable may comprise one or more other components, such as an aerosol generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

For completeness, aerosol provision devices comprising an inductive element are known. The aerosol provision device may comprise one or more inductors and a susceptor which is arranged to be heated by the one or more inductors.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The aerosol provision device that is configured to generate the varying magnetic field is referred to as a magnetic field generator, herein.

Various embodiments will now be described in more detail.

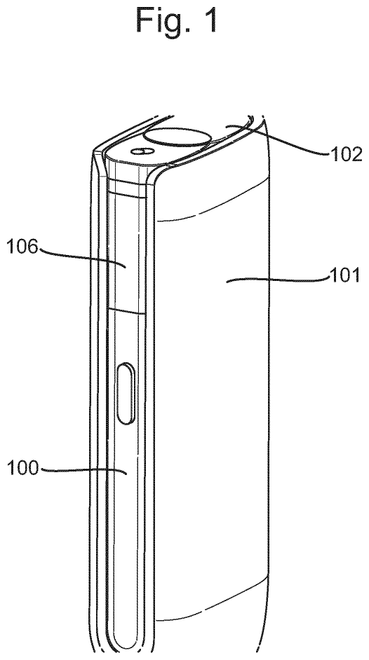

FIG. 1 shows an aerosol provision device 100 according to an embodiment shown located within an elongate cavity of a charging unit 101. The charging unit 101 may comprise a power source (not shown). The power source may include, for example, a battery (single-use or rechargeable), a rechargeable super capacitor, a rechargeable solid-state battery (SSB), a rechargeable lithium-ion battery (LiB) or the like, a hermetically sealed battery, a pouch cell battery or some combination thereof. Whilst the aerosol provision device 100 is shown in combination with a charging unit 101, it will be appreciated that the aerosol provision device 100 may be provided with power by any other means. For example, a power source provided with aerosol provision device 100 may be charged by plugging a power supply into the aerosol provision device 100, or the power source may be replaceable, e.g. in the form of a replaceable battery.

The aerosol provision device 100 may be left in the charging unit 101 for a predetermined time in order to allow sufficient charging of the aerosol provision device 100. For example, the charging unit 101 may be arranged to charge the aerosol provision device 100 to full charge in a time of <10 mins, 10-20 mins, 20-30 mins, 30-40 mins, 40-50 mins, 50-60 mins or >60 mins.

The charging unit 101 and/or the aerosol provision device 100 may optionally have an indicator to give a visual or other representation to the user of the charging level of the aerosol provision device 100. Additionally, there may be a separate indicator to give a visual representation of the charge level of the charging unit 101. The current charge level of the aerosol provision device 100 and/or the charging unit 101 may be determined by control means disposed in the aerosol provision device 100 and/or the charging unit 101.

The visual indicator may comprise one or more light-emitting diodes (LEDs). However, other embodiments are contemplated where the visual indicator may be replaced by an audio indicator (e.g. a speaker) or a haptic indicator.

The aerosol provision device 100 may comprise an outer housing which may have a tubular and/or cylindrical shape. However, other embodiments are envisaged wherein the aerosol provision device 100 may take other desired forms e.g. the aerosol provision device 100 may be boxed shaped. According to an embodiment the outer housing 108 of the aerosol provision device 100 may comprise an electrical insulator and may, for example, be formed of polyether ether ketone (“PEEK”).

According to an embodiment the distal end of the aerosol provision device 100 may comprise one or more orientation features and/or one or more magnets for securing the distal end of the aerosol provision device 100 to a base portion of the charging unit 101.

The aerosol provision device 100 may be inserted into the cavity of the charging unit 101 in order to recharge the aerosol provision device 100 by receiving electrical power from the charging unit 101. The charging unit 101 may comprise an internal battery to provide electrical power to the aerosol provision device 100. The charging unit 101 may also be connected to an external source of electrical power.

The charging unit 101 may comprise a lid or cover 102 which may be slid by a user between an open and closed position. The lid or cover 102 is provided at the entrance to the cavity which is provided within the charging unit 101 and which is configured to receive the aerosol provision device 100.

The aerosol provision device 100 includes an aerosol generator for generating aerosol from aerosol generating material. According to an embodiment the aerosol provision device 100 comprises a resistive heater for heating an aerosol generating article.

When the lid or cover 102 is in the open position an opening to the cavity is exposed thereby enabling a user to either remove the aerosol provision device 100 from the charging unit 101 (in order to use the aerosol provision device 100) or alternatively to insert the aerosol provision device 100 into the charging unit 101 (in order to charge the aerosol provision device 100).

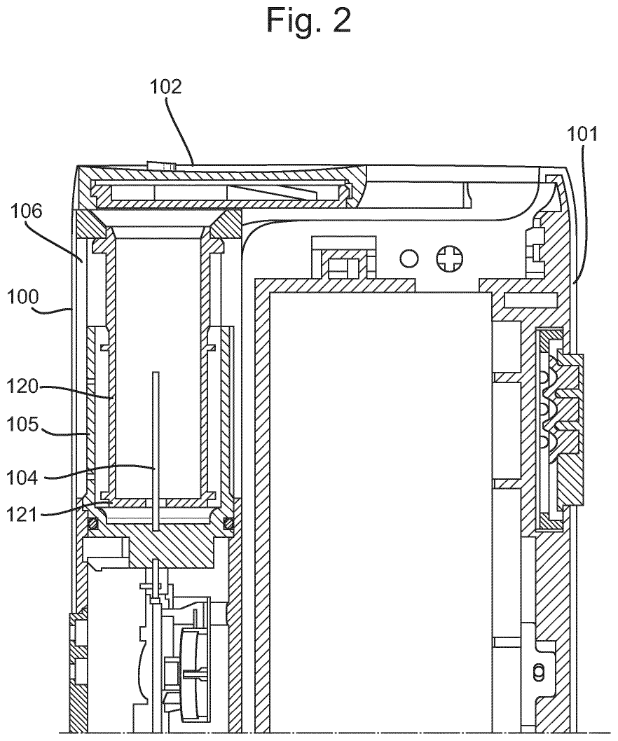

FIG. 2 shows a cross-sectional view showing the aerosol provision device 100 located or docked within the charging unit 101. The aerosol provision device 100 comprises a main housing 105 wherein a heating element 104, e.g. a resistive heating element 104, projects within the main housing 105. The aerosol provision device 100 further comprises a removable cap 106 which may be magnetically attached to the main housing 105.

The removable cap 106 includes a receptacle 120 for receiving a consumable. In use, an aerosol generating article is inserted in the receptacle 120. The receptacle 120 comprises a tubular housing having a base portion 121. The base portion 121 of the receptacle 120 has an aperture and the resistive heating element 104 is arranged to project through the aperture. An aerosol generating article may be inserted into the aerosol provision device 100 by inserting the aerosol generating article through an opening in the removable cap 106 and then inserting the aerosol generating article into the receptacle 120 and onto the heating element 104. The heating element 104 has a blade like profile and in use an aerosol generating article may be forced onto the heating element 104 so that the blade like profile of the heating element 120 inserts into a distal end of the aerosol generating article. The heating element 104 is arranged to internally heat the aerosol generating article.

At the end of a session of use, when an aerosol generating article has been consumed, the removable cap 106 may then be detached from the main housing 105. It will be understood that the process of detaching the removable cap 106 will have the effect that the base portion 121 of the receptacle 120 will contact a bottom face of the aerosol generating article. As the removable cap 106 is withdrawn, then the base portion 121 of the receptacle 120 will contact the distal end of the aerosol generating article and will result in the aerosol generating article being pulled off or otherwise removed from the heating element 104.

However, over a period of time the heating element 104 may become dirty and may become covered with a deposit of spent aerosol generating material from the aerosol generating article. Accordingly, it may be desirable periodically to clean the heating element 104.

Cleaning the heating element of a conventional aerosol provision device can be problematic but according to various embodiments one or more apertures may be provided in the main housing 105 which enable a tool, such as a cleaning tool, to clean the heating element 104 by being passed through the one or more apertures in order to clean the heating element 104. It will be understood that the cleaning is performed after the removable cap 106 has been detached from the main housing 105.

The one or more cleaning apertures which are provided in the main housing 105 according to various embodiments are described in more detail below.

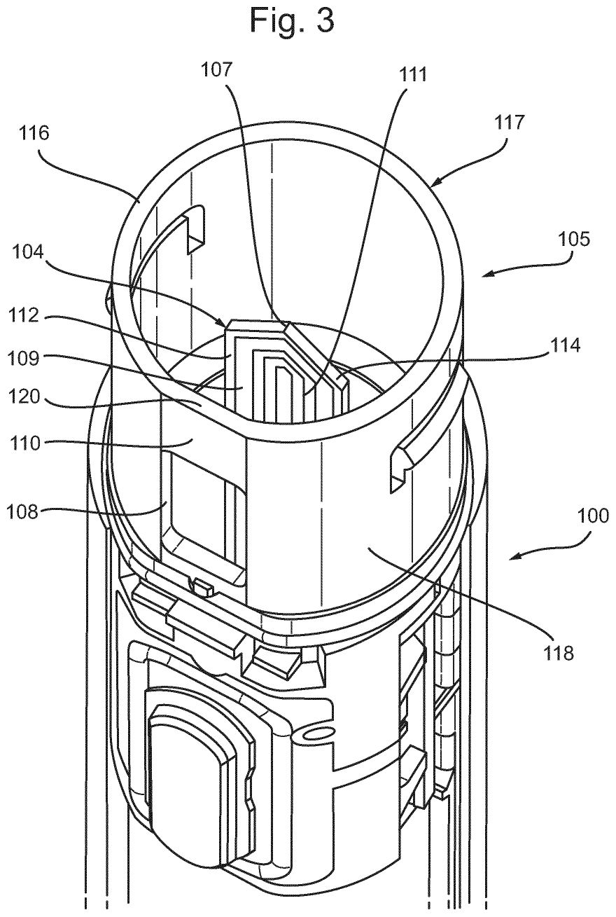

FIG. 3 shows a perspective view, from above, of the aerosol provision device 100 with the removable cap 106 removed, so as to reveal the main housing 105. The main housing 105 comprises a tubular element 117. As depicted, the heating element 104 extends within the tubular element 117. Whilst a tubular element 117 with a substantially circular profile is depicted, it will be appreciated that the tubular element 117 may have any suitable profile. The tubular element 117 comprises a first aperture 108 through which a tool (not depicted) can be inserted, in use. The tool may comprise a cleaning tool and/or a tool to assist in the removal of a portion of an aerosol generating article that may be attached to the heating element 104.

The first aperture 108 provides a convenient means of accessing the heating element 104 and thereby facilitating cleaning or other maintenance of the heating element 104. The first aperture 108 may allow improved access to the heating element 104 and thereby facilitate improved cleaning. This may improve the operation of the aerosol provision device 100 and/or improve the lifespan of the heating element 104 and thus the aerosol provision device 100. Additionally, the first aperture 108 may facilitate the removal of an aerosol generating article or a portion of an aerosol generating article from the heating element 104. This may allow a user to more easily remove the aerosol generating article and/or remove an aerosol generating article which was otherwise stuck on the heating element 104.

The heating element 104 may comprise a substrate 109 having one or more conductive tracks 111 provided thereon, and the substrate 109 may extend within the body of the tubular element 117. The heating element 104 may have a pointed tip 107. In some embodiments, as depicted, the heating element 104 may comprise a first face 112, an edge portion 114 and a second face (not visible in FIG. 3 but which is on the opposite side of the heating element 104 to the first face 113). In some embodiments, as depicted in FIG. 3, the first aperture 108 is aligned with (i.e. the first aperture 108 may face) the first face 112. As the first face 112 may be an area which requires cleaning, aligning the first aperture 108 with this first face 112 may allow easy inspection, access to, and cleaning of the first face 112. The aperture 108 may, for example, extend in a plane parallel to a plane in which the first face 112 of the heating element 104 extends, such that it is aligned with the first face 112 of the heating element 104.

The first aperture 108 may be located at any suitable location in the tubular element 117 so as to provide appropriate access within the tubular element 117. In some embodiments, as depicted, the tubular element 117 may have a truncated circular cross section comprising a first arcuate section 116 having a curved outer surface 118 and a second linear section 120 having a planar outer surface 110. The first aperture 108 may be located in the second linear section 120, i.e. within the planar outer surface 110.

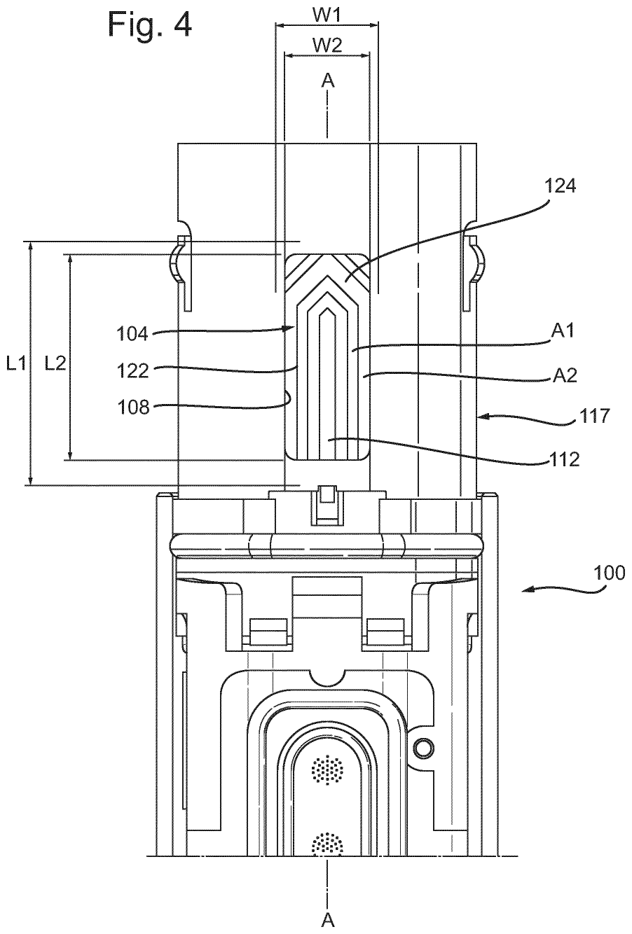

FIG. 4 shows a side-on view of the aerosol provision device 100 with the removable cap 106 removed. In some embodiments, as depicted, the first aperture 108 may be elongated in a direction parallel to a longitudinal axis A of the tubular element 105. This may provide access, via the first aperture 108, to a substantial length of the heating element 104.

The first aperture 108 may have a shape, i.e. a profile, that substantially corresponds to the shape of the heating element 104. Whilst the heating element 104 may comprise a pointed tip, the heating element 104 may otherwise be considered to be substantially rectangular in shape. As depicted, the first aperture 108 may also have a corresponding rectangular shape. This may allow access to at least the first face 112 of the heating element 104.

Whilst the entire heating element 104 cannot be seen in FIG. 4, the heating element has a first profile which has a first length L1, a first width W1 and a first surface area A1. The first aperture 108 has a second profile which has a second length L2, a second width W2 and a second area A2. As can be seen in FIG. 4, the first aperture 108 has a substantially rectangular profile. Whilst the profile of the heating element 104 is not identical to that of the first aperture 108, it will be appreciated that the first profile substantially corresponds to the second profile. As a result of the corresponding profiles of the first aperture 108 and the heating element 104, suitable access within the tubular element 117, e.g. to the heating element 104, may be achieved.

In the embodiment depicted, the ratio of the first length L1 to the second length L2, i.e. L1/L2, is approximately 1.2-1.3. However, any first aperture 108 and heating element 104 in which the second length L2 and first length L1 are similar may be used. For example, the ratio L1/L2 may be in the range 0.5-0.6, 0.6-0.7, 0.7-0.8, 0.8-0.9, 0.9-1.0, 1.0-1.1, 1.1-1.2, 1.2-1.3, 1.3-1.4 or 1.4-1.5. It will be appreciated that any of the ratios set out above may provide appropriate access to the heating element 104 within the tubular element 117.

In the embodiment depicted, the ratio of the first width W1 to the second width W2, i.e. W1/W2, is approximately 1.2-1.3. However, any first aperture 108 and heating element 104 in which the second width W2 and first width W1 are similar may be used. For example, the ratio W1/W2 may be in the range 0.5-0.6, 0.6-0.7, 0.7-0.8, 0.8-0.9, 0.9-1.0, 1.0-1.1, 1.1-1.2, 1.2-1.3, 1.3-1.4 or 1.4-1.5. It will be appreciated that any of the ratios set out above may provide appropriate access to the heating element 104 within the tubular element 117.

Similarly, in the embodiment depicted, the ratio of the first area A1 to the second area A2, i.e. A1/A2, is approximately 0.8-1.2. However, any first aperture 108 and heating element 104 in which the first area A1 and second area A1 are similar may be used. For example, the ratio A1/A2 may be in the range 0.5-0.6, 0.6-0.7, 0.7-0.8, 0.8-0.9, 0.9-1.0, 1.0-1.1, 1.1-1.2, 1.2-1.3, 1.3-1.4 or 1.4-1.5. It will be appreciated that any of the ratios set out above may provide appropriate access to the heating element 104 within the tubular element 117

The heating element 104 may have any suitable shape capable of heating a medium arranged within the tubular element 105. For example, as depicted, the first profile of the heating element 104 comprise a polygonal profile. In the example depicted, the heating element 105 comprises a substantially rectangular portion 122 adjoined to a triangular portion 124, which together define a five-sided polygonal shape. The triangular portion 124, of the heating element 104, defines the pointed tip 107 (see FIG. 3) which may be used to penetrate a consumable article as the consumable article is inserted into the device 100.

The heating element 104 may instead comprise any other suitable profile and for example the first profile of the heating element 104 may comprise: a triangular, square, rectangular, pentagonal, hexagonal, septagonal or octagonal profile. The second profile (i.e. the profile of the first aperture 108) may also comprise a polygonal profile. In the embodiment depicted, the second profile of the first aperture 108 comprises a rectangular profile.

Similarly to the first profile, the second profile (i.e. the profile of the first aperture 108) may comprise any other suitable profile, for example: a triangular, square, rectangular, pentagonal, hexagonal, septagonal or octagonal profile. The first profile of the heating element 104 and the second profile of the aperture 108 may have a corresponding shape. For example, where the first profile of the heating element 104 has a rectangular shape, the second profile of the first aperture 108 may have a rectangular shape. In the embodiment depicted, the second profile of the first aperture 108 substantially matches at least part of the first profile of the heating element 104, e.g. the rectangular portion 122 thereof. Having corresponding profiles may provide sufficient access to the heating element 104 through the first aperture 108. In the embodiment depicted, the first aperture 108 has a rectangular profile and may have a length L2 in the range 1-30 mm, 3-20 mm, or 5-10 mm. The width W2 of the first aperture 108 may be in the range 1-15 mm, 2-8 mm, or 3-5 mm. In the exemplary case whereby the length L2 is, for example, 20 mm and the width W2 is, for example, 4 mm, the first aperture 108 may have an area of approximately 80 mm².

Having appropriate profiles and/or relative sizes of the first aperture 108 and the heating element 104 may beneficially ensure that a tool, such as a cleaning tool, is able to reach appropriate portions of the heating element 104 to perform cleaning thereon or to remove a consumable article affixed thereto. This may help to ensure that the heating element 104 can be appropriately cleaned and maintained thereby ensuring the appropriate operation of the heating element 104 and the aerosol provision device 100.

Although FIGS. 3 and 4 show an embodiment wherein a single first aperture 108 is provided in the tubular element 105, it will be appreciated that the tubular element 105 may comprise at least one further aperture i.e. at least a second aperture.

In some embodiments, the tubular element 105 comprises a second or further aperture through which a tool can also be inserted, in use, in order to clean the heating element 104 and/or to remove an aerosol generating article attached to the heating element 104. Whilst not depicted, it will be appreciated that the second or further aperture may be arranged in any suitable position on the tubular element 105. For example, in some embodiments, the second or further aperture may be aligned with the second face of the heating element 104. The second face may be the face on the opposite side of the heating element 104 to the side on which the face 112 is present. The presence of a second or further aperture aligned with this second face may beneficially facilitate the cleaning of the second face of the heating element 104.

The second or further aperture may be located opposite the first aperture 108. According to further embodiments a different number of apertures may be provided as required. The number of apertures may depend on the shape of the heating element 104 and/or the potential number of faces of the heating element 105 which may require cleaning.

It will understood that according to various embodiments the heating element 105 may comprises a planar blade shaped heating element having two opposed planar faces and wherein the aerosol provision device comprises either one or two apertures 108 which provide cleaning access to one or both sides of the heating element 105.

Other embodiments are contemplated wherein a second or further aperture may be located at an angle relative to the first aperture 108. The second aperture may be inclined at an angle <30°, 30-60°, 60-90°, 90-120°, 120-150° or 150-180° relative to the first aperture. Arranging the second or further aperture at this location may beneficially allow a tool, such as a cleaning tool, to be inserted into the tubular element 105 in a different direction to the direction inserted via the first aperture 108. This may allow further parts of the heating element 104, which may not otherwise be reachable from the first aperture 108, to be cleaned. For example, this may provide access to an edge portion 114 (see FIG. 3) of the heating element 104.

Whilst in the embodiments described above the heating element 104 is in the form of a resistive heating element, it will be appreciated that the heating element 104 may be any other suitable element which may require cleaning or to which a consumable article may become attached. For example, the heating element 104 may comprise a component of an inductive heating element e.g. a susceptor. In such embodiments, the aerosol provision device 100 may comprise suitable components, as are well known in the art, for causing an inductive heating element to generate heat.

In some embodiments, the aerosol provision device 100 forms part of an aerosol generating system which further comprises an aerosol generating article (not shown), which may be inserted into the aerosol provision device. For example, the aerosol generating article may be inserted into the tubular element 117, so as to be in contact with the heating element 104.

The first aperture 108 described above, and indeed the further aperture(s) described above, may in addition, or alternatively, form an inspection port. In this instance, in some embodiments, a method of manufacturing an aerosol provision device is disclosed comprising using an inspection device (not shown) to inspect the heating element 104. The inspection device may comprise any device which can be used to inspect the heating element. For example, the inspection device may comprise a laser which irradiates the heating element, as well as a detector arranged to detect radiation reflected from the heating element. An output of the inspection device may be analysed to assess one or more properties of the heating element 104 and/or the orientation of the heating element 104. The inspection port may also advantageously facilitate improved calibration of the heating element and its associated heating profile. In some embodiments, the inspection device may comprise an imaging device and may comprise taking one or more images of the heating element 104 through the aperture or inspection port 108. The imaging device may, in some embodiments, comprise a camera. It will be appreciated, that it may not be necessary for the inspection port 108 to comprise a full aperture through the tubular element 105. Accordingly, in some embodiments, the first aperture 108 may be replaced with an inspection port 108 which may be transparent at least to radiation of a specific wavelength. In some embodiments, the inspection port 108 may include an optically transparent member.

In some embodiments, the method may further comprise analysing the one or more images in order to assess one or more properties of the heating element 104 and/or the orientation of the heating element 104.

In some embodiments, the tubular element 117 may comprise multiple apertures or multiple inspection ports 108. In such embodiments, the method of manufacturing may comprise taking one or more images of the heating element 104 through each of the inspection ports 108. This may beneficially facilitate imaging of different portions, e.g. sides or faces, of the heating element 104. This method may beneficially allow improved determination as to whether the heating element 104 has been inserted in the correct orientation and that conductive tracks provided on the heating element 104 have been formed correctly.

Furthermore, it is also contemplated that the heating element 104 may be tested as part of a quality control procedure and the heating element 104 may be observed via the one or more inspection ports 108 during this procedure.

In some embodiments, analysis of the one or more images may be performed and, depending on the results of the analysis of the images, remedial action may be taken regarding the heating element 104. For example, the heating element 104 may be moved or replaced.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device comprising:
a main housing comprising a tubular element surrounding a heating element;
wherein the tubular element comprises a first aperture through which a tool can be inserted, in use, in order to clean the heating element and/or to assist in the removal of an aerosol generating article attached to the heating element.

2. An aerosol provision device as claimed in claim 1, further comprising a removable cap which is attached, in use, to the main housing.

3. An aerosol provision device as claimed in claim 1, wherein the heating element has a first profile, a first length L1, a first width W1 and a first surface area A1 and the first aperture has a second profile, a second length L2, a second width W2 and a second area A2.

4. An aerosol provision device as claimed in claim 3, wherein the first profile substantially corresponds with the second profile.

5. An aerosol provision device as claimed in claim 3, wherein L1/L2 is in the range 0.5-0.6, 0.6-0.7, 0.7-0.8, 0.8-0.9, 0.9-1.0, 1.0-1.1, 1.1.-1.2, 1.2-1.3, 1.3-1.4 or 1.4-1.5.

6. An aerosol provision device as claimed in claim 3, wherein W1/W2 is in the range 0.5-0.6, 0.6-0.7, 0.7-0.8, 0.8-0.9, 0.9-1.0, 1.0-1.1, 1.1-1.2, 1.2-1.3, 1.3-1.4 or 1.4-1.5.

7. An aerosol provision device as claimed in claim 3, wherein A1/A2 is in the range 0.5-0.6, 0.6-0.7, 0.7-0.8, 0.8-0.9, 0.9-1.0, 1.0-1.1, 1.1-1.2, 1.2-1.3, 1.3-1.4 or 1.4-1.5.

8. An aerosol provision device as claimed in claim 3, wherein L2 is in the range 1-30 mm, 3-20 mm, or 5-10 mm.

9. An aerosol provision device as claimed in claim 3, wherein W2 is in the range 1-15 mm, 2-8 mm, or 3-5 mm.

10. An aerosol provision device as claimed in claim 3, wherein the first profile comprises a polygonal profile.

11. (canceled)

12. An aerosol provision device as claimed in claim 3, wherein the second profile comprises a polygonal profile.

13. (canceled)

14. An aerosol provision device as claimed in claim 1, wherein the tubular element has a longitudinal axis and the first aperture is elongated in a direction parallel to the longitudinal axis.

15. (canceled)

16. (canceled)

17. An aerosol provision device as claimed in claim 1, wherein the heating element comprises a first face, an edge portion and a second face and wherein the first aperture is aligned with the first face.

18. An aerosol provision device as claimed in claim 17, wherein the tubular element further comprises a second aperture through which a tool can be inserted, in use, in order to clean the heating element and/or to assist in the removal of an aerosol generating article attached to the heating element.

19. An aerosol provision device as claimed in claim 18, wherein the second aperture is aligned with the second face.

20. An aerosol provision device as claimed in claim 18, wherein the second aperture is located opposite the first aperture.

21. An aerosol provision device as claimed in claim 1, wherein the tubular element has a truncated circular cross-sectional profile comprising a first arcuate section having a curved outer surface and a second linear section having a planar outer surface.

22. An aerosol provision device as claimed in claim 21, wherein the first aperture is located in the second linear section.

23. An aerosol provision device as claimed in claim 18, wherein the second aperture is inclined at an angle <30°, 30-60°, 60-90°, 90-120°, 120-150° or 150-180° relative to the first aperture.

24. An aerosol generating system comprising:
an aerosol provision device as claimed in claim 1; and
an aerosol generating article.

25. A method of manufacturing an aerosol provision device comprising:
locating a tubular element around a heating element, the tubular element having a first inspection port; and
using an inspection device to inspect the heating element through the first inspection port.

26-54. (canceled)
